(19) United States
(12) Patent Application Publication
(10) Pub. No.: US 2015/0026711 A1
(43) Pub. Date: Jan. 22, 2015

(54) METHOD AND APPARATUS FOR VIDEO CONTENT DISTRIBUTION

(71) Applicants: Ola Andersson, Spanga (SE); Jan Erik Lindquist, Alvsjo (SE)

(72) Inventors: Ola Andersson, Spanga (SE); Jan Erik Lindquist, Alvsjo (SE)

(73) Assignee: TELEFONAKTIEBOLAGET L M ERICSSON (PUBL), Stockholm (SE)

(21) Appl. No.: 14/381,086

(22) PCT Filed: Feb. 27, 2012
(86) PCT No.: PCT/EP2012/053290

§ 371 Date: Aug. 26, 2014

(51) Int. Cl. H04N 21/2343; H04N 21/45; H04N 21/81; H04N 21/24

(52) U.S. Cl. CPC H04N 21/23439; H04N 21/2407; H04N 21/4508; H04N 21/812
USPC 725/14

(57) ABSTRACT

Accordingly, there is provided a client device for receiving video content from a server, the client device comprising a processor. The processor is arranged to determine if a particular clip has been played. If it is determined that the client has played the particular clip, the processor is arranged to increase the quality of a video content that is played. By determining if a particular clip has been played before increasing the quality of video content that is played, a user of the client device is encouraged to watch the particular clip before watching the video content.

### TECHNICAL FIELD

The present application relates to a client device; a server for serving video content; a method in a client device; a method in a server; and a computer-readable medium.

### BACKGROUND

Existing media players on computer platforms are often used as enablers, meaning that the same media player enables media playback for a number of different services/applications which saves the different applications from including media player functionality themselves. Examples of media players on computer platforms that are enablers are Apple Quicktime™ and VLC media player. (VLC used to stand for VideoLAN Client, but since VLC is no longer simply a client, that acronym no longer applies.) Both of these can serve not only as proper media player applications but also as enablers for other applications to include video playback functionality. The enabling function is achieved by exposing application programming interfaces (APIs) towards 3rd party applications, sometimes as part of a software development kit (SDK) e.g. the Quicktime SDK.

A good example of a media player enabler on mobile platforms is the video player included on the Android platform, most Android applications containing video playback use the video player that is part of the Android multimedia framework.

Using the same video enabler from multiple applications/services instead of having each application contain its own video player is cost efficient. The efficiency applies to the application developer, as they don't have to invest in creating their own media player. The efficiency also applies to the platform as the re-use of a core video enabler is more memory and performance efficient.

However, a drawback of such an approach is that each application is restricted to the same video behavior. The video enablers in use today are typically seen as black boxes. The video enablers contain all of the often complex logic that relates to video playback and yet they expose only very basic video APIs for applications to use. This means that different applications that would benefit from specific and slightly different video behavior all must be satisfied with the common features exposed by the video enabler.

MediaSource APIs are being developed to begin to address some of the above problems with existing media players. Work has begun to define and standardize MediaSource APIs to create media enablers that are more powerful than that which is currently in use. This work is ongoing as part of the development of HTML 5 and current documentation is still in draft form. See for example http://code.google.com/p/html5-mediasource-api/. The current proposal is to use JavaScript APIs for enhanced media control. This will enable web browsers and other applications that use javascript to get detailed control of the video playback, e.g. to control the manifest file for adaptive streaming up in the service layer.

HTTP Adaptive Bitrate Streaming (also known as Adaptive HTTP Streaming) is a technique used in streaming media over computer networks. While in the past most video streaming technologies utilized streaming protocols such as Real Time Streaming Protocol (RTSP) and Real-time Transport Protocol (RTP), today's adaptive streaming technologies are almost exclusively based on HTTP and designed to work efficiently over large distributed HTTP networks such as the Internet.

HTTP Adaptive Bitrate Streaming works by detecting both the available bandwidth in a connection to a device and the processing capacity of the device. This information is then used to select the quality of a media stream to be streamed to the device. This requires the media stream to be available for streaming in multiple versions at multiple bit rates. The media playing client in the device switches between streaming the different versions depending on available resources. HTTP Adaptive Bitrate Streaming is generally accepted to provide media streaming with limited stalling, and fast start time, thus providing a good user experience with both devices using a high capacity connection and those using low capacity connections.

Adaptive bitrate streaming is described in U.S. Pat. No. 7,818,444 awarded to Move Networks, Inc. and which is incorporated herein by reference.

Commercial broadcast television (TV) is traditionally interrupted by commercial breaks 3-4 times every hour. This form of advertisement funded commercial television worked well for many years. In recent years progress in technology has resulted in hard disk based personal video recorders and on-demand TV becoming increasingly popular. These trends have conspired to lower the value of traditional TV advertisement (ad) slots. Users generally like and now expect to be able to fast forward past the commercial breaks.

One way to halt the decline in value of TV ad slots is to prevent users from fast forwarding past commercial breaks. This can only be implemented in situations where the service provider controls the media player (e.g. in a broadcaster's own web TV offering) and it also has the potential drawback of being annoying for the user, blocking a feature he expects to have.

The TV industry is currently looking for new ways of providing commercial information to the TV subscribers, this includes options such as product placement. Further, the TV industry is considering revenue generation from ad free “premium” subscriptions, sometimes referred to as a “freemium” model.

Further, there is a problem that there is an overhead in the system in the communication required to initiate a streaming session. If a user initiates and starts watching a content stream but after watching the content stream for a few seconds decides to stop watching, then this communication overhead is wasted. Further, there is also an overhead in the time taken at the client end to set up the streaming session, including buffering. Such an overhead can be many seconds for high quality, high bandwidth, content stream.

Accordingly, there is a need for an improved method and apparatus for video content distribution.

### SUMMARY

This document presents methods and apparatus that allows TV users to choose whether to watch commercials or not, and for TV service providers to reward the users that do watch commercials with better TV quality.

The methods and apparatus presented herein also allows a TV service provider to begin streaming a piece of video content at low quality before initiating a high quality stream. This allows a user to ensure the selected program is appropriate before incurring the overhead related to setting up a high quality stream.

Accordingly, there is provided a client device for receiving video content from a server, the client device comprising a processor. The processor is arranged to determine if a particular clip has been played. If it is determined that the client has played the particular clip, the processor is arranged to increase the quality of a video content that is played.

By determining if a particular clip has been played before increasing the quality of video content that is played, a user of the client device is encouraged to watch the particular clip before watching the video content.

The clip may be a first portion, or a taster, of the video content allowing the user to determine if the video content is the correct one they wish to watch. Such an implementation reduces bandwidth consumption associated with buffering and streaming video content for a user to watch the first few second before selecting something else.

Alternatively, the clip may be an advertisement, in which case the above described method allows a content provider to encourage a user to watch an advertisement before watching the content. Such an incentive increases the value of the advertising slot while still allowing a user freedom of action in how the watch content.

The client device may further comprising a user interface arranged to receive a video content selection.

The client device may be further arranged to identify a particular clip for the client device. The particular clip may be selected according to the requested video content. The particular clip may be selected according to the client device. The particular clip may be selected according to a user account associated with the client device. The identifying may comprise querying a server. The identifying may comprise receiving the identity of the particular clip from a server in response to a query.

The client device may further comprise a receiver for receiving video content and clips from at least one server. The client device may further comprise a decoder for decoding video content and clips. The client device may further comprise a display for displaying video content and clips. The client device may further comprise an output suitable for connecting to a display, the display for displaying video content and clips.

There is further provided a server for serving video content to at least one client device, the server comprising at least one processor. The at least one processor is arranged to determine if a client has downloaded a particular clip. If it is determined that the client has downloaded the particular clip, the processor is further arranged to increase the quality of a video content made available to the client. The server may be further arranged to serve the video content to the client.

The processor may be further arranged to determine if the client has played the particular clip, and to increase the quality of a video content made available to the client if it is determined that the client has downloaded and played the particular clip.

The server may further comprise a storage component for storing video content and clips. The server may further comprise a memory for recording what clips the client has downloaded, and for recording at what quality a particular video content may be made available to the client.

The clip may be an advertisement. The clip may comprise video content and audio content. The clip may be streamed from the server to the client device. The clip may be streamed from the server to the client device using HTTP adaptive streaming.

There is further provided a method, in a client device for receiving video content from a server. The method comprises determining if a particular clip has been played. The method further comprises increasing the quality of a video content that is played if it is determined that the client has played the particular clip.

There is further provided a method, in a server for serving video content to at least one client device. The method comprises determining if a client has downloaded a particular clip. The method further comprises increasing the quality of a video content made available to the client if it is determined that the client has downloaded the particular clip.

There is further provided a computer-readable medium, carrying instructions, which, when executed by computer logic, causes said computer logic to carry out any of the methods defined herein.

There is further provided a computer-readable storage medium, storing instructions, which, when executed by computer logic, causes said computer logic to carry out any of the methods defined herein.

### BRIEF DESCRIPTION OF THE DRAWINGS

An improved method and apparatus for video content distribution will now be described, by way of example only, with reference to the accompanying drawings, in which:

FIG. 1 illustrates an example content distribution system;

FIG. 2 illustrates an example of how the content distribution system of FIG. 1 may operate;

FIG. 3 illustrates a method for video content distribution; and

FIG. 4 illustrates a further method for video content distribution.

### DETAILED DESCRIPTION

The method and apparatus disclosed herein uses mediasource APIs to allow a TV Application in the service layer to track which commercials the user watches and to present him with higher quality video based on this.

As a preliminary example, consider a user that starts to watch a movie on-demand on his TV. The movie is adaptively streamed over HTTP (HTTP Adaptive Streaming, HAS) starting at a lower quality. Initially, before the movie is started, the user is informed that for each advertisement he chooses to watch the viewing quality of the movie will increase one step, for a maximum of 5 steps. An advertisement can be started whenever the user wants by pressing a specific button on the remote control, e.g. the green color button. Now, the user has the choice of watching 5 ads right away in order to start the movie at the highest possible quality from the beginning. Alternatively, the use may start watching the movie at lower quality and eventually increase the quality once he finds out that the movie is good enough to spend time watching.

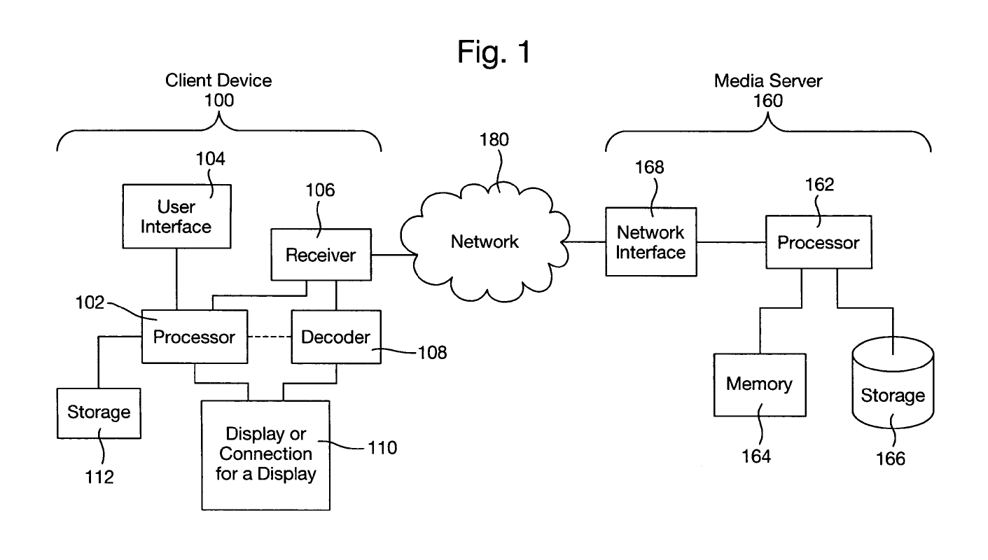

FIG. 1 illustrates an example content distribution system comprising a client device 100 connected to a media server 160 via a network 180. The client device comprises a processor 102, a user interface 104, a receiver 106, a decoder 108, a display or a connection for a display 110, and a memory 112. The processor 102 receives input from a user of the client device 100 via the user interface 104. The receiver 106 receives content from the network 180 and passes this to the decoder 108 for decoding and subsequent output to the user via a display or a connection for a display 110. The receiver 106 operates under control of the processor 102. The processor 102 has a storage 112 associated therewith. Storage 112 may be a memory for storing instructions for execution by processor 102. Storage 112 may also store content and/or clips that have been received but which may be displayed later.

Media server 160 comprises a processor 162, a memory 164, a storage component 166, and a network interface 168. The processor 162 is arranged to receive instructions which, when executed, causes the processor 162 to carry out the method described herein. The instructions are stored in the memory 164. Memory 164 may also store a record of which client devices have downloaded and/or played back content from the media server 160. Content for distribution to client devices 100 is stored in the storage component 166 of media server 160. The network interface 168 receives stored content from the storage device 166 and transmits this over the network 180 to the client device 100.

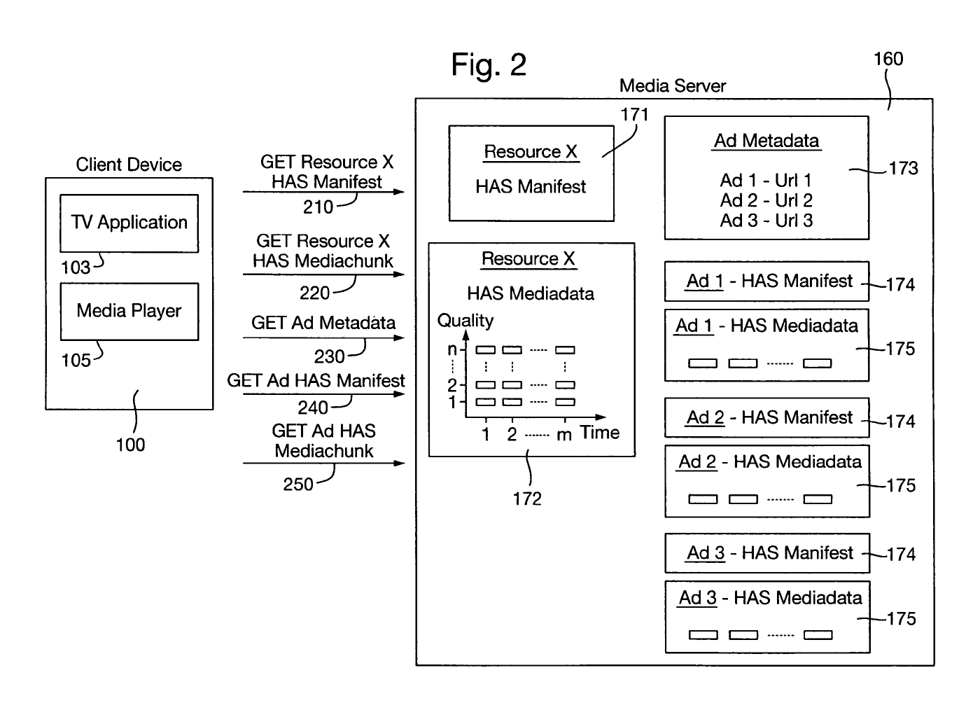

FIG. 2 illustrates an example of how the content distribution system of FIG. 1 may operate. FIG. 2 illustrates the client device 100 as comprising a TV application 103 and a media player 105. Further, media server 160 is shown as comprising: an HTTP Adaptive Streaming (HAS) manifest 171 for resource X; HAS media data 172 also for resource X; Ad metadata 173, and manifests 174 and media chunks 174 in respect of three ad clips.

When a TV session for resource X is initiated by a user, the client side TV Application 103 requests 210 the resource X manifest from the media server 160. The client side TV application 103 receives the manifest file 171 which describes, among other things, all the available video quality versions for resource X. The client side TV application 103 also makes a request 230 to the media server 160 to get metadata 173 for the advertisement video clips related to resource X.

The TV service provider has pre-configured the TV Application with information regarding the maximum allowed quality (quality M) at which the streaming may start. The TV Application uses javascript/ajax to request 220 video chunks following the normal HAS procedure, getting chunks at a quality level up to the quality M and passes on the chunks to the media player via the mediasource APIs.

When the user elects to play one of the advertisement videos, the TV application 103 requests 240 a HAS ad manifest 174 for a particular ad clip. The ad clip may be selected by the user, or it may be selected by the TV application 103. After receiving the HAS ad manifest 174 for the particular clip the TV application 103 requests 250 ad clip media chunks 175 in accordance with HAS. If the client device 100 plays the ad clip at normal speed (i.e. the user does not fast forward through the commercial) the TV Application 103 increments the quality level by increasing the maximum allowed quality to M+1 which gives the possibility for the video to be viewed at a better video quality, subject to the constraints of HAS.

The client device 100 is typically a Set-top box or a smart TV within the user's home. The TV Application 103 is the actual TV Service that is presented to the user, containing EPG, video store, buttons, menus etc. Where the client device 100 is a thin client, the TV application 103 may be written in JavaScript and executed in a JavaScript engine, referred to as a “browser” throughout this document.

Not all logic is written in javascript and the TV Application 103 relies on a number of lower level enabler components, one of them being the Media Player 105, where the API between the TV Application 103 and the Media Player 105 is provided by the described Mediasource APIs.

Media server 160 is illustrated comprising only one video, resource X. Resource X is prepared for HAS, which means that it has a separate manifest file 171 plus a number of media data chunks 172. In a similar manner each advertisement clip is also prepared with manifest 174 and media data 175.

An additional component that is used in this scenario is the Ad Metadata 173. Using this, the client device 100 can identify the available advertisements and how to address them. In a normal broadcast TV scenario this is not needed since the ads arrive to the client as part of the TV stream but in this case, when ads are to be delivered “on demand” they must be separated from the resource. In order to allow the client device 100 to fetch the needed data the server must expose the necessary API. This is normally an HTTP Rest based API.

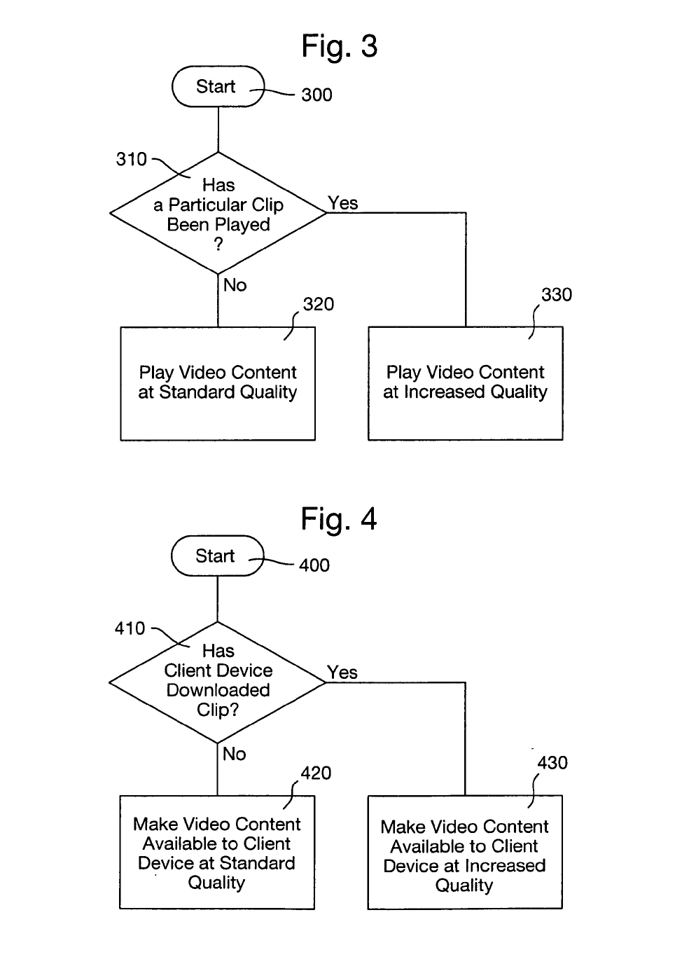

FIG. 3 illustrates a method for video content distribution. The method is performed in response to a request for a video content, and/or periodically during playback of video content. The method may be performed in a client device. The method begins at 300 and proceeds immediately to 310 where a determination is made as to whether a particular clip has been played. If the clip has not been displayed then the video content is played at standard quality 320. If the clip has been played then at 330 the video content is played at increased quality.

FIG. 4 illustrates a further method for video content distribution. The method is performed in response to a request for a video content, and/or periodically during playback of video content. The method may be performed in a media server or a content distribution node. The method may be performed in respect of a plurality of client devices connected to the media server. The method begins at 400 and proceeds immediately to 410 where a determination is made as to whether a particular clip has been downloaded by a client device. If the clip has not been downloaded then the video content is made available at standard quality 420. If the clip has been downloaded then at 430 the video content is made available at increased quality.

The improved method and apparatus for video content distribution described herein gives the user an incentive to watch commercials. Since the reward (better quality) is instant this may turn the general user experience of commercial breaks as negative into a more positive experience. It also addresses the current issue of either having user fast forward through the commercials or having media players disable fast forwarding when commercials are showed.

The method above relies on a client side browser with javascript logic provided by the service provider where the client side logic fully controls the player behavior, quality levels, etc. The media server is only required to provide standard HAS information for the main video (e.g. movie) and the related advertisements, plus metadata information about the advertisements enough for the browser to present them to the user (e.g. the order in which they are to be played). This puts security requirements on the client to prevent users from modifying or hacking the client device to get top quality content without having the right to it.

An alternative solution is to place more logic on the server having the server control each session for each user keeping track of the user's highest allowed quality level. The server would always know when a user watches an advertisement since the client would ask for the advertisement chunks and thus the server would increase the user's quality level when this happens. This would make it transparent to the client but would put higher performance requirements on the server.

It will be apparent to the skilled person that the exact order and content of the actions carried out in the method described herein may be altered according to the requirements of a particular set of execution parameters. Accordingly, the order in which actions are described and/or claimed is not to be construed as a strict limitation on order in which actions are to be performed.

While examples have been given in the context of HTTP Adaptive Streaming, these examples are not intended to be the limit of streaming system to which the disclosed method and apparatus may be applied. The principles disclosed herein can be applied to any streaming system which uses a description file. For example, this method and apparatus may be applied to Apple™ HTTP Live Streaming, and Microsoft™ Smooth Streaming.

Further, while examples have been given in the context of a particular communications network, these examples are not intended to be the limit of the communications networks to which the disclosed method and apparatus may be applied. The principles disclosed herein can be applied to any communications network which carries media using streaming, including both wired IP networks and wireless communications networks such as LTE and 3G networks.

1. A client device for receiving video content and a particular clip from a server, the client device comprising a processor, the processor being arranged to:
determine if the particular clip has been played by the client device; and
send a request to the server for an increased quality version of a video content in response to determining that the client has played the particular clip.

2. The client device of claim 1, further comprising a user interface arranged to receive a video content selection.

3. The client device of claim 1, further arranged to identify a particular clip for the client device.

4. The client device of claim 1, further comprising a receiver for receiving video content and clips from at least one server.

5. The client device of claim 1, further comprising a decoder for decoding video content and clips.

6. The client device of claim 1, further comprising a display for displaying video content and clips

7. The client device of claim 1, further comprising an output suitable for connecting to a display, the display for displaying video content and clips.

8. A server for serving one of standard quality video content and increased quality video content and a particular clip to a client device, the server comprising at least one processor arranged to:
determine whether to make available to the client device the increased quality video content, wherein
the processor is arranged to determine whether to make the increased quality video content available to the client device by performing a process comprising: determining whether the client device has downloaded the particular clip.

9. The server of claim 8, further arranged to serve the video content to the client.

10. The server of claim 8, wherein the process further comprises: determining whether client has played the particular clip, wherein the processor is arranged to make the increased quality video content available to the client device as a result of determining that the client device has downloaded and played the particular clip.

11. The server of claim 8, further comprising a storage component for storing video content and clips.

12. The server of claim 8, further comprising a memory for recording what clips the client has downloaded, and for recording at what quality a particular video content may be made available to the client.

13. The server of claim 1, wherein the clip is an advertisement.

14. The server of claim 1, wherein the clip comprises video content.

15. The server of claim 1, wherein the video content further includes audio content.

16. The server of claim 1, wherein the video content is streamed from the server to the client device.

17. A method, in a client device, for receiving video content and a particular clip from a server, the method comprising:
determining if the particular clip has been played by the client device; and
requesting from the server an increased quality version of the video content as a result of determining that the client has played the particular clip.

18. A method, in a server for serving video content and a particular clip to at least one client device, the method comprising:
determining if a client has downloaded or played a particular clip, and
making available to the client device an increased quality version of the video content as a result of determining that the client has downloaded or played the particular clip.

19. A computer-readable medium, carrying instructions, which, when executed by computer logic, causes said computer logic to carry out method defined by claim 17.

20. A computer-readable medium, carrying instructions, which, when executed by computer logic, causes said computer logic to carry the method defined by claim 18.
